(19) United States
(12) Patent Application Publication
(10) Pub. No.: US 2017/0048347 A1
(43) Pub. Date: Feb. 16, 2017

(54) METHOD, APPARATUS AND SYSTEM FOR DISTRIBUTED CACHE REPORTING THROUGH PROBABILISTIC RECONCILIATION

(71) Applicant: INTERDIGITAL PATENT HOLDINGS, INC., Wilmington, DE (US)

(72) Inventor: Dirk Trossen, London (GB)

(73) Assignee: INTERDIGITAL PATENT HOLDINGS, INC., Wilmington, DE (US)

(21) Appl. No.: 15/304,204

(22) PCT Filed: Apr. 15, 2015
(86) PCT No.: PCT/US2015/025998

§ 371 Date: Oct. 14, 2016

Related U.S. Application Data
(60) Provisional application No. 61/979,800, filed on Apr. 15, 2014.

(51) Int. Cl. H04L 29/08

(52) U.S. Cl. CPC H04L 67/2842; H04L 67/327

(57) ABSTRACT

Methods, apparatuses and systems may be used to populate and utilize content in distributed network attachment point (NAP) caches with the help of a statistical cache report synchronization scheme that may be tuned in terms of bandwidth consumption for the synchronization and overall surety of the retrieval requests, and therefore, the incurred penalty in terms of latency. One example references a particular statistical synchronization scheme based on a Bloom filter reconciliation set technique. Each NAP of a plurality of NAPs may receive a list of unique NAP identifiers (NAPIds) of neighboring NAPs at regular intervals. A first NAP may receive a first content request for a requested content. On a condition that the requested content is not located in a caching database of the first NAP, the first NAP may determine the NAPId of a second NAP likely holding the requested content and issue a content request.

### CROSS REFERENCE TO RELATED APPLICATIONS

This application is the U.S. National Stage, under 35 U.S.C. §371, of International Application No. PCT/US2015/025998 filed Apr. 15, 2015, which claims the benefit of U.S. Provisional Application No. 61/979,800 filed Apr. 15, 2014, the contents of which are hereby incorporated by reference herein.

### BACKGROUND

Content delivery networks (CDNs) are used in the Internet to accelerate the retrieval of web content, including videos, in order to improve the latency experienced by end users. Current CDN deployments employ relatively large centralized storage elements to which content requests are re-directed when a user makes a request, for example, through a hypertext transfer protocol (HTTP)-based protocol.

In the attempt to further reduce service-level latency, caching closer to the end user is currently investigated in many forms. Edge gateway solutions for mobile networks are one avenue where the edge gateways store content being previously retrieved from the served region in an attempt to improve on future requests.

### SUMMARY

Methods, apparatuses and systems may be used to populate and utilize content in distributed network attachment point (NAP) caches with the help of a statistical cache report synchronization scheme that may be tuned in terms of bandwidth consumption for the synchronization and overall surety of retrieval requests, and therefore, an incurred penalty in terms of latency. One example references a particular statistical synchronization scheme which may be based on a Bloom filter reconciliation set technique. In one example, the routing for a particular content from one NAP to another may be based on name-specific tables, where each content identifier (ID) (CId), not necessarily flat, may point to at least one NAP, or even to none, in which case the content may be pulled from a central storage. These name-specific tables may constitute a distributed state across the participating base stations. In one example, Bloom filters are used for probabilistically reconciling this distributed state.

Reporting of a cache utilization state in distributed cache environments may be done through a statistical set synchronization approach. In an example, information may be received and extracted from received statistical set synchronization information to derive a probabilistic picture of the cache utilization in the distributed caches at each individual caching entity. In another example, the cache utilization state in distributed cache environments may be reported and the probabilistic picture of the cache utilization may be derived, where the statistical synchronization approach is based upon a Bloom filter based set reconciliation technique. In another example, content information may be requested and received based on the statistical picture of the cache utilization in the distributed caches at the individual caching entities. In another example, protocol and system domain architectures within the network and the interface description between the domains may be used to enable, collate, share and process cache utilization reports within centralized, distributed or clustered methods and procedures. In another example, protocol and system domain architectures within the network and the interface description between the domains may be used to enable, collate, share and process content retrieval requests within centralized, distributed or clustered methods and procedures.

Each NAP of a plurality of NAPs may receive a list of unique NAP identifiers (NAPIds) of neighboring NAPs at regular intervals. A first NAP, a second NAP and/or a third NAP may be located in a small-cell network. The first NAP may receive a first content request for a requested content. On a condition that the requested content is not located in a caching database of the first NAP, the first NAP may determine the NAPId of the second NAP likely holding the requested content and issue a content request for the requested content to the second NAP.

On a condition that the requested content is located in the caching database of the second NAP, the second NAP may deliver the requested content to the first NAP. On a condition that the requested content is not located in the caching database of the second NAP, the second NAP may deliver a first miss message to the first NAP.

In an example, on a condition of the receipt of the first miss message, the first NAP may issue a third content request for the requested content to a centralized manager. In another example, on a condition of the receipt of the first miss message, the first NAP may determine the NAPId of the third NAP likely holding the content requested. The third NAP may issue a third content request for the requested content to the third NAP. On a condition that the requested content is located in the caching database of the third NAP, the third NAP may deliver the requested content to the first NAP. On a condition that the requested content is not located in the caching database of the third NAP, the third NAP may deliver a first miss message to the first NAP.

In an example, the first NAP may create a synchronization set containing one or more content identifiers and one or more NAPIds of the caching database of the first NAP at set intervals. In another example, the first NAP may synchronize the caching database of the first NAP with the caching databases of neighboring NAPs, wherein the caching databases are probabilistically synchronized until synchronization is complete. In a further example, the first NAP may use Bloom filters in the synchronization of the caching database of the first NAP.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of an example of a small-cell backhaul in an end-to-end mobile network infrastructure;

FIG. 2 is a system diagram of the main components of an example caching system;

FIG. 3 is a flow diagram of an example caching system flow; and

FIG. 4 is a signal diagram of an example of signaling in a caching system.

### DETAILED DESCRIPTION

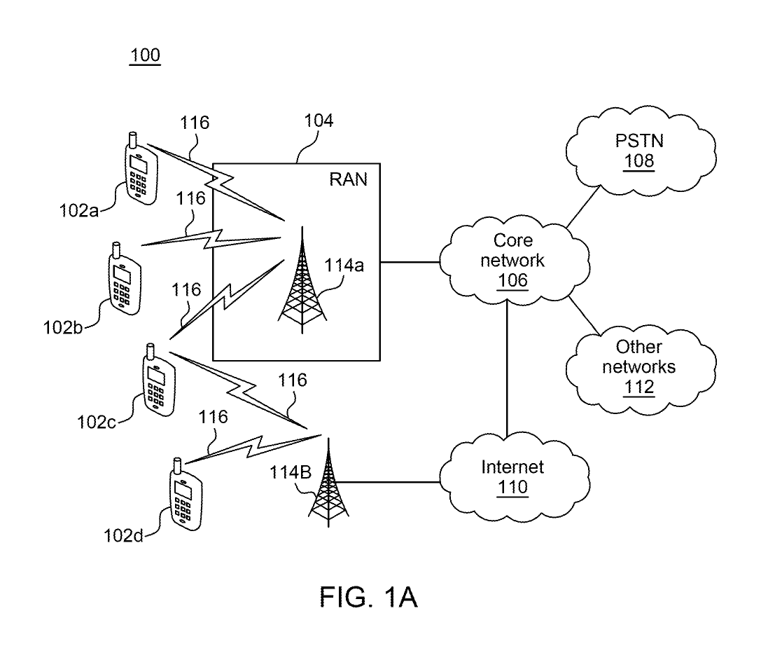

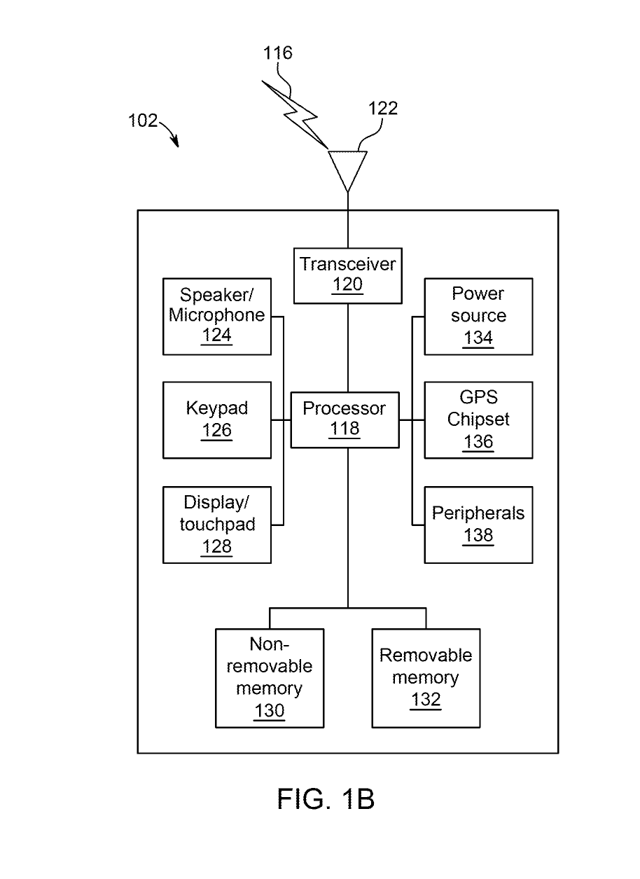

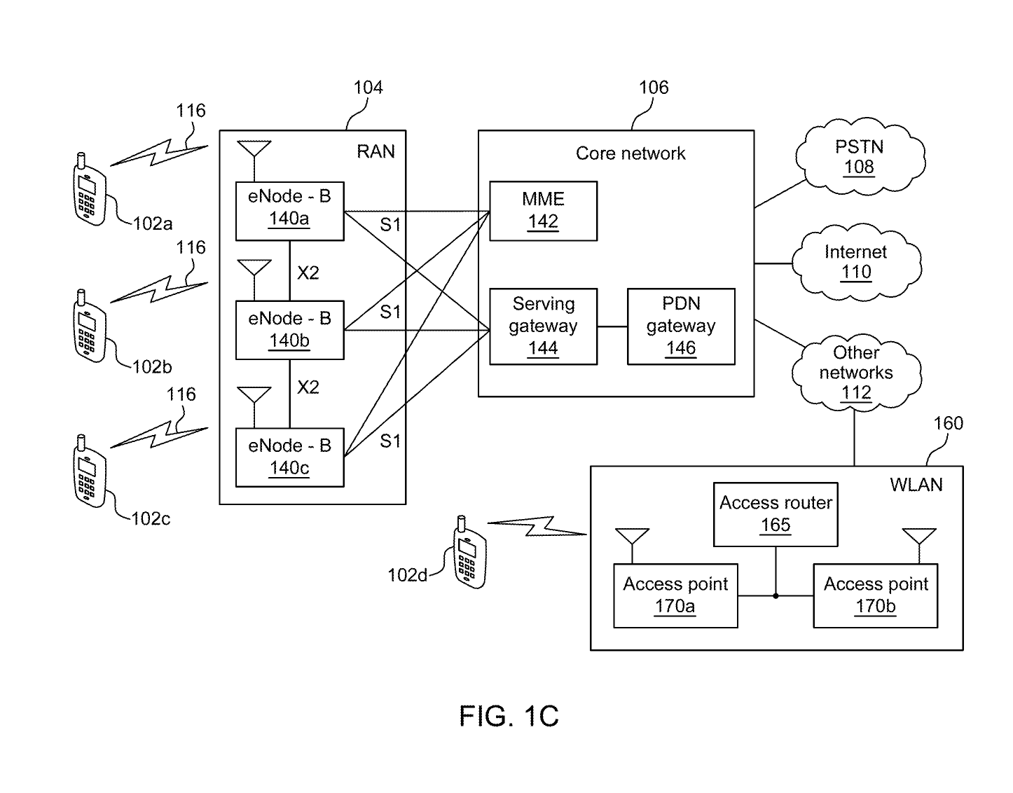

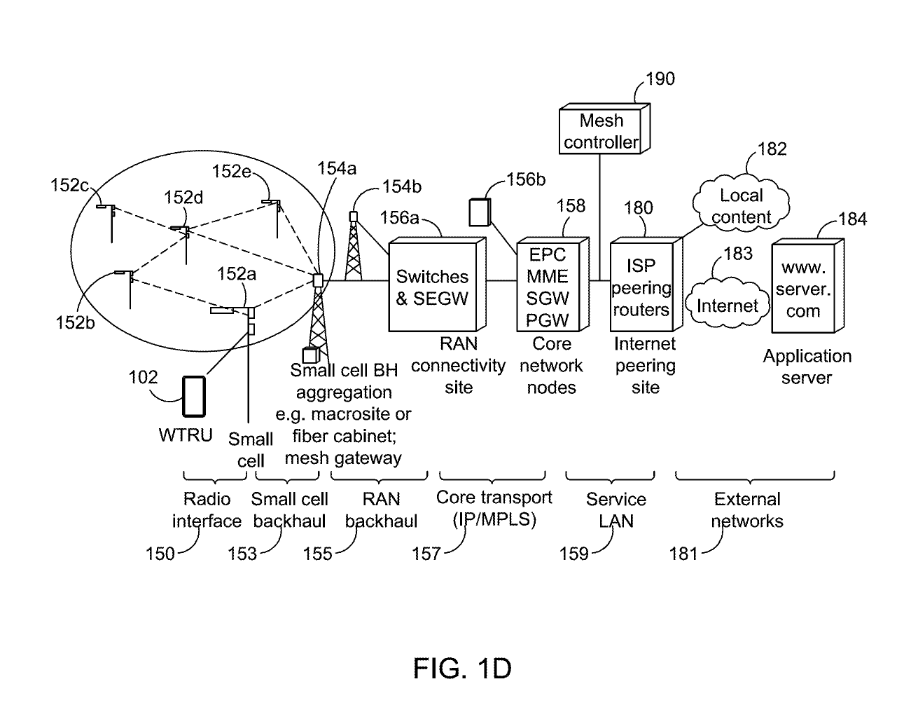

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, a network attachment point (NAP) and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (for example, radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (VViMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (for example, WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (for example, the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (for example, multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (for example, a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (for example, nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (for example, longitude and latitude) regarding the current location of the WTRU 102. In addition to, or in lieu of, the information from the GPS chipset 136, the WTRU 102 may receive location information over the air interface 116 from a base station (for example, base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an Si interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the Si interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (for example, an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Other network 112 may further be connected to an IEEE 802.11 based wireless local area network (WLAN) 160. The WLAN 160 may include an access router 165. The access router 165 may contain gateway functionality. The access router 165 may be in communication with a plurality of access points (APs) 170a, 170b. The communication between access router 165 and APs 170a, 170b may be via wired Ethernet (IEEE 802.3 standards), or any type of wireless communication protocol. AP 170a may be in wireless communication over an air interface with WTRU 102d.

FIG. 1D is a system diagram of an example of a small-cell backhaul in an end-to-end mobile network infrastructure. A set of small-cell nodes 152a, 152b, 152c, 152d, and 152e and aggregation points 154a and 154b interconnected via directional millimeter wave (mmW) wireless links may comprise a “directional-mesh” network and provide backhaul connectivity. For example, the WTRU 102, or multiple such WTRUs, may connect via the radio interface 150 to the small-cell backhaul 153 via small-cell node 152a and aggregation point 154a. Each small-cell node 152a, 152b, 152c, 152d, and 152e may support one or more small-cell networks. In an example, the aggregation point 154a provides the WTRU 102 access via the RAN backhaul 155 to a RAN connectivity site 156a. The WTRU 102 therefore then has access to the core network nodes 158 via the core transport 157 and to internet service provider (ISP) 180 via the service LAN 159. The WTRU also has access to external networks 181 including but not limited to local content 182, the Internet 183, and application server 184. It should be noted that for purposes of example, the number of small-cell nodes 152 is five; however, any number of nodes 152 may be included in the set of small-cell nodes.

Aggregation point 154a may include a mesh gateway node. A mesh controller 190 may be responsible for the overall mesh network formation and management. The mesh-controller 190 may be placed deep within the mobile operator's core network as it may responsible for only delay insensitive functions. In an embodiment, the data plane traffic (user data) may not flow through the mesh-controller. The interface to the mesh-controller 190 may be only a control interface used for delay tolerant mesh configuration and management purposes. The data plane traffic may go through the serving gateway (SGW) interface of the core network nodes 158.

The aggregation point 154a, including the mesh gateway, may connect via the RAN backhaul 155 to a RAN connectivity site 156a. The aggregation point 154a, including the mesh gateway, therefore then has access to the core network nodes 158 via the core transport 157, the mesh controller 190 and ISP 180 via the service LAN 159. The core network nodes 158 may also connect to another RAN connectivity site 156b. The aggregation point 154a, including the mesh gateway, also may connect to external networks 181 including but not limited to local content 182, the Internet 183, and application server 184.

As used herein, reconciliation may refer to synchronization and the terms may be used interchangeably. As used herein, content retrieval requests may refer to content requests and the terms may be used interchangeably.

The routing for a particular content from one NAP to another may be based on name-specific tables, where each content identifier (ID) (CId), not necessarily flat, may point to one or more NAPs, or even to none, in which case the content may be pulled from the central storage. These name-specific tables may constitute a distributed state across the participating base stations. In one example, Bloom filters may be used for probabilistically reconciling this distributed state. This synchronization may be tuned in terms of speed of convergence with levels of probabilistic synchronization of the distributed tables and used bandwidth for synchronization of these tables.

This scheme may allow for better utilizing the communication resources of the, for example, radio or fiber, backhaul network. If content already exists in one NAP, the content may be pushed again from the centralized storage to the second NAP (for example, in anticipation of a handover) since this will incur a hefty consumption of communication resources over time, when considering constant user movements. The caching system may use direct communication capabilities between base stations, such as through mesh networking capabilities, which would reduce the burden on the backhaul towards the centralized storage element. For this to happen, the distributed state in the form of name-specific tables may exist at the different NAPs, at least at a probabilistic level.

Reporting of a cache utilization state in distributed cache environments may be done through a statistical set synchronization approach. In an example, information may be received and extracted from received statistical set synchronization information to derive a probabilistic picture of the cache utilization in the distributed caches at each individual caching entity. In another example, the cache utilization state in distributed cache environments may be reported and the probabilistic picture of the cache utilization may be derived, where the statistical synchronization approach is based upon a Bloom filter based set reconciliation technique. In another example, content information may be requested and received based on the statistical picture of the cache utilization in the distributed caches at the individual caching entities. In another example, protocol and system domain architectures within the network and the interface description between the domains may be used to enable, collate, share and process cache utilization reports within centralized, distributed or clustered methods and procedures. In another example, protocol and system domain architectures within the network and the interface description between the domains may be used to enable, collate, share and process content retrieval requests within centralized, distributed or clustered methods and procedures.

When pushing such content delivery solutions even closer to the user, one option may be caching of content right at the NAP For example, a base station of a mobile network, through enhancing each NAP with appropriate storage facilities may cache content. However, it is likely that the storage capabilities of such an enhanced NAP are still relatively small in relation to the possibly large content that could be retrieved within the cell that the NAP is serving. Hence, edge network caching solutions may employ a regionally centralized intelligence that coordinates the management of the content within a served region, while the content itself is stored across the individual enhanced NAPs. The role of this centralized intelligence is to coordinate which longer lived content might need to be disseminated to a particular NAP, for example, in anticipation for its usage by a user that moves from one NAP to another.

Examples described herein extend the state-of-the-art in cached content retrieval by using a hybrid of a distributed cache storage and reporting mechanism with centralized fallback storage. Cached content retrieval requests may be issued to nearby base stations that might hold the desired content rather than a more distant centralized storage. An effective design for such a mechanism may demand sufficient information based upon which such cache retrieval requests could be issued.

Such information may be sufficiently probabilistic in nature in order to allow issuance of a first-order retrieval request. Upon failure of such a first-order request, a fall back to the centralized storage may be issued for retrieving the content with surety. Such probabilistic knowledge of cached content in nearby base stations may be achieved by sharing cache reports as identifier sets which in turn are reconciled, i.e., synchronized, through techniques such as repeated Bloom filter based updates. These identifier sets may be stored within each NAP in conjunction with a unique NAP identifier (NAPId) for each set. When the NAP receives a request from the centralized storage to retrieve a cached content (if not existing already in the NAP storage), the NAP may utilize the individual cache report sets to determine the nearby NAP which might, probabilistically, hold the requested item. If such a nearby NAP is found, the cached content may be requested from the NAP and the content may be delivered, in the case of the cached content existing at the identified NAP. Or, in the case of the cache content not existing at the identified NAP, a “miss” notification may be sent instead, upon which the requesting NAP may contact the centralized storage to deliver the item.

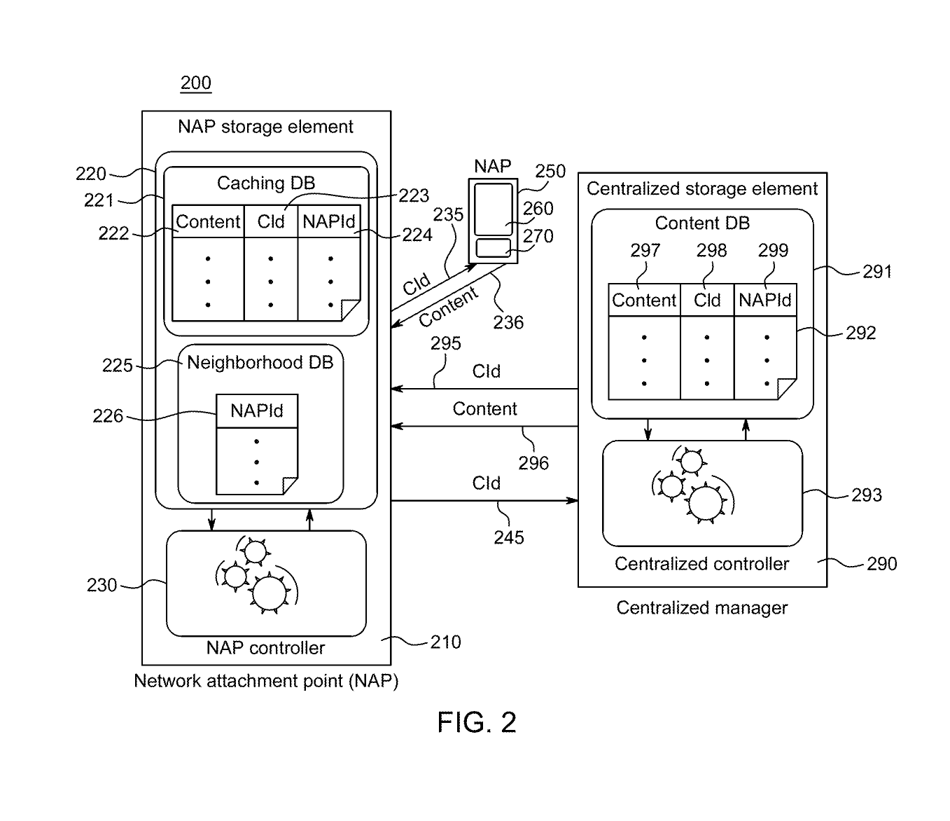

FIG. 2 is a system diagram of the main components of an example caching system. As shown in the system 200, a NAP 210 may include a NAP storage element 220 and a NAP controller 230. A NAP storage element 210 may hold a caching database 221 with the following columns. A content items column 222 may include items according to application layer specific semantics (for example, encoded pictures, text, and the like). A column of unique CIds 223 may include CIds, each of which is associated with one entry of the caching database under a content item of the previous column. A column of unique NAPIds 224 may include those NAPs that hold the CId of this row.

The NAP storage element 220 may also hold a neighborhood database 225 with a NAPId column 226. The NAPId column 226 may include unique NAPIds of NAP elements to be contacted for content retrieval.

A NAP controller 230 may implement several procedures. The NAP controller 230 may intercept content requests from individual users with a subsequent checking whether or not the content resides in its caching database 221 and, in case of a positive result, delivering the response to the content request to the originating user. The NAP controller 230 may also send content items based on requests received from other NAPs, such as NAP 250, towards the NAP 250. Further, the NAP controller may also send content retrieval requests for particular CIds 235 towards another NAP 250. If the requested content resides in the caching database of the NAP storage element 260 of the other NAP 250, the other NAP 250 may send the content 236 to the NAP 210. In addition, the NAP controller 230 may send content retrieval requests for particular CIds 245 towards a centralized storage controller 293. If the requested content resides in the content database 292 of the centralized storage element 291 of the centralized manager 290, the centralized manager 290 may send the content 296 to the NAP 210. Further, the NAP controller 230 may reconcile row entries for particular NAPIds 224 based on a set reconciliation mechanism.

A centralized storage element 291 in the centralized manager 290 may hold a content database 292 with the following columns. A content items column 297 may include items according to application layer specific semantics (for example, encoded pictures, text, etc.). A column of unique CIds 298 may include CIds, each of which is associated with one entry of the caching database under a content item of the previous column. A column of unique NAPIds 299 may include those NAPs that hold the CIds of this row.

A centralized controller 293 in the centralized manager 290 may implement several procedures. The centralized controller 293 may send content retrieval requests for particular CIds 295 towards a particular NAP, such as NAP 210, based on a given decision logic. The centralized controller 293 may also send content 296 towards a particular NAP or a set of NAPs in a multipoint manner. In addition, the centralized controller 293 may receive and process content retrieval requests for particular CIds 245.

In one example, the caches for content reside at each individual NAP, i.e., nearest to the end user. When the end user formulates a content request, for example, using an HTTP GET primitive for a web page element, the NAP may use an interception technique to determine whether or not the requested content resides in its local caching database. A number of such interception techniques may be used, such as deep packet inspection (DPI), and the like. If the interception indicates that the content does reside in the NAP-local caching database, an appropriate response may be generated and the content may be delivered back to the end user.

The centralized controller may employ a variety of mechanisms to populate the content database, such as application-layer DPI (which might operate on content requests routed through the centralized controller in a particular implementation of this example), by exposing a dedicated publication application programming interface (API) and the like.

The caching system may rely on neighborhood awareness. The caching system may use neighborhood awareness to retrieve content using locals NAPs instead from the centralized controller. For that, the centralized controller may generate for each NAP i a list of unique identifiers for neighboring NAP entities. This list of NAPIds may be sent to NAP i at regular intervals, accounting for possible changes in the network topologies. The update, as well as the selection logic for the NAPIds, may be applied using known techniques and the like.

The decision concerning which content is to be placed in which NAP caching database may be implemented in the centralized storage controller, based on some decision logic. The decision logic may take into account, for instance, time of day, history of usage (for example, least frequently used or last recently used items) or any other predictive mechanism that uses, for instance, contextual information otherwise obtained. Alternatively, the NAP could make an autonomous decision which content is to be cached locally, based on, for example, locally available information about the usage of this content in the near future. The decision logic as well as the mechanism to obtain the necessary information for this decision logic may be applied using known techniques and the like.

Once such decision has been made, the centralized controller may send a request to the identified NAP, such as NAP 210, to obtain a particular content, using the unique CId 295 for this content. Hashing techniques may be used to generate (statistically) unique identifiers for given content objects.

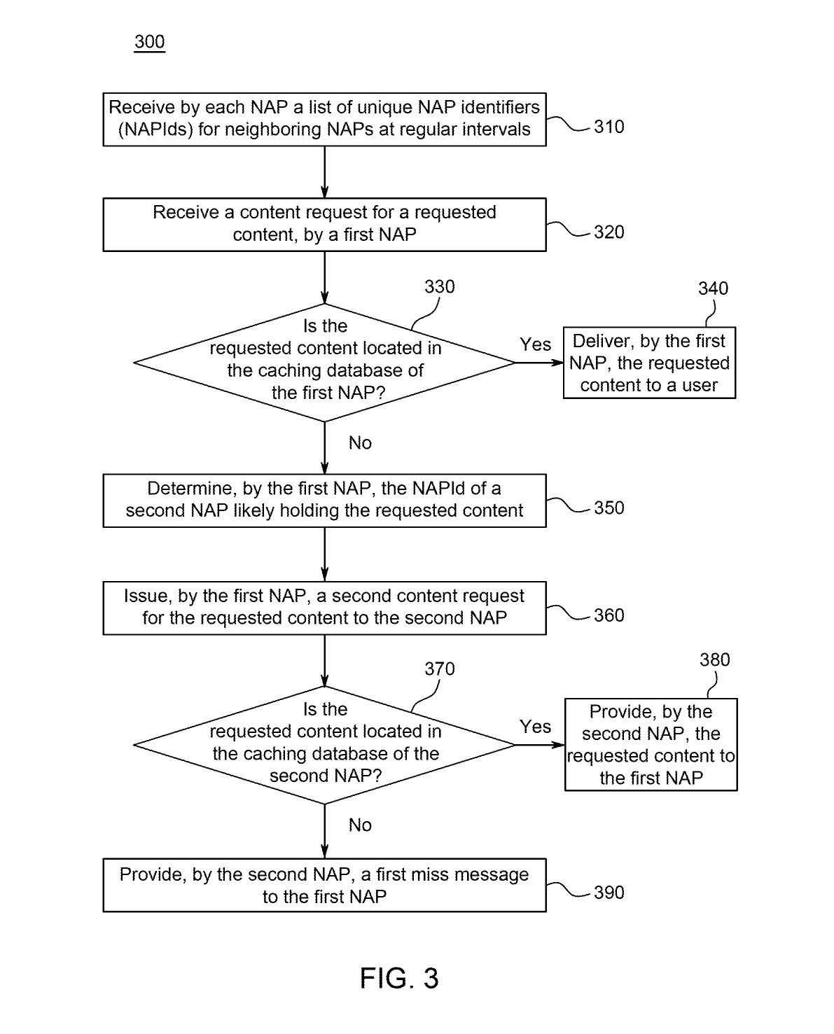

FIG. 3 is a flow diagram of an example caching system flow. As shown in the flow 300, each NAP may receive a list of unique NAPIds of neighboring NAPs at regular intervals 310, as discussed above.

Further, upon receiving the content population request at the NAP 320, the NAP may consult its NAP caching database, such as caching database 221, in order to retrieve the content 330. If the content is located in the caching database 221, the NAP 210 may then deliver the requested content to a user. If the content is not located in the caching database 221, the NAP 210 may consult the appropriate column in the caching database 221 to determine the identifier of the NAP that likely holds the content instead 350. If there are more than one NAPIds available, the NAP controller 230 may use algorithms like shortest distance vector or probabilistic load balancing to determine the most appropriate NAP. For this, the NAP controller 230 may utilize any information such as congestion on the link towards the NAP or radio conditions on the link towards the NAP (for example, in wireless backhaul scenarios). If there is no NAPId available, the NAP 210 may request the content directly from the centralized controller 293 and insert the content 296 upon reception from the centralized controller together with its own NAPId in the appropriate column for the content row.

Once the NAP, such as NAP 250, from which to receive the content is determined, the NAP controller 230 may issue a content retrieval request with a CId 235 to the identified NAP 250 in order to retrieve the content 360. Upon receiving a content retrieval request at the identified NAP 250, the identified NAP controller 270 may consult its own NAP content database with regards to the availability of the requested content 370. If available, the requested item, such as content 236, may be returned 380 to the requesting NAP 210, and the requesting NAPId may be inserted in the caching database of the identified NAP 250. If the requested content is not available, a “miss” message may be returned 390 to the requesting NAP 210.

Upon receiving a successful reply from the identified NAP 250, the requesting NAP 210 may insert the content into its own NAP storage element 220. Optionally, the NAP 210 might complement the content information with the information about the identified NAPId, simplifying future retrieval requests by relying on this additional information.

Upon receiving a “miss” reply, the requesting NAP 210 may re-issue another content retrieval request in case another NAPId is available in its caching database 221. Alternatively, the requesting NAP 210 may issue a content retrieval request with a CId 245 to the centralized controller 293, which in turn may reply with the requested content 296, while the centralized controller may insert the NAPId in its own content database.

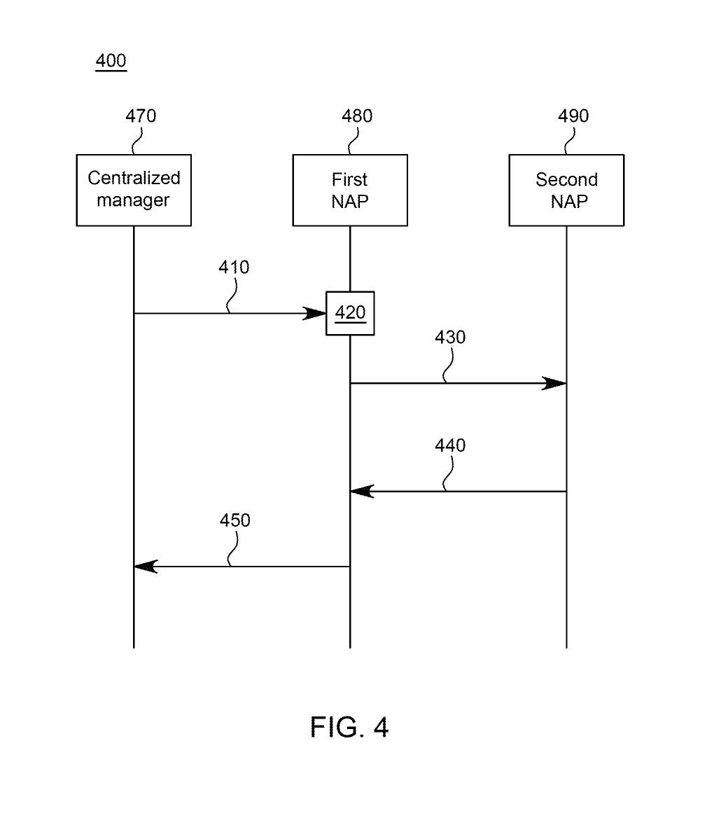

FIG. 4 is a signal diagram of an example of signaling in a caching system. In an example, each NAP, including a first NAP 480, may receive, from a centralized manager 470, a list of unique NAPIds for neighboring NAPs at regular intervals 410. As shown in the signaling 400, upon receiving a first content request for a requested content at the first NAP 480, the first NAP 480 may consult its NAP caching database, such as caching database 221, in order to retrieve the content 420. On a condition that the requested content is located in the caching database 221, the first NAP may then deliver the requested content to a user. On a condition that the requested content is not located in the caching database 221, the first NAP 480 may then determine the NAPId of a second NAP 490 likely holding the requested content. The first NAP 480 may then issue a second content request for the requested content 430 to the second NAP 490.

Upon receiving a content retrieval request at the second NAP 490, the second NAP 490 may consult its own NAP content database with regards to the availability of the requested content. On a condition that the requested content is located in the caching database of the second NAP 490, the second NAP 490 may deliver the requested content 440 to the first NAP 480. The first NAP 480 may then deliver the requested content to a user.

On a condition that the requested content is not located in the caching database of the second NAP 490, the second NAP 490 may deliver a first miss message to the first NAP 480. The first NAP 480 may then issue a third content request for the requested content 450 to the centralized manage 470. The centralized manager 470 may then provide the requested content to the first NAP 480 and the first NAP 480 may then deliver the requested content to a user.

In an example, after receiving the first miss message, the first NAP 480 may then determine the NAPId of a third NAP likely holding the requested content. The first NAP 480 may then issue a third content request for the requested content to the third NAP. On a condition that the requested content is located in the caching database of the third NAP, the third NAP may deliver the requested content to the first NAP 480. The first NAP 480 may then deliver the requested content to a user.

On a condition that the requested content is not located in the caching database of the third NAP, the third NAP may deliver a second miss message to the first NAP 480. In an example, the first NAP 480 may then issue a fourth content request for the requested content 450 to the centralized manage 470. The centralized manager 470 may then provide the requested content to the first NAP 480 and the first NAP 480 may then deliver the requested content to a user.

Each NAP may choose to implement a local cache replacement strategy, such as least frequently used (LFU) or last recently used (LRU), to replace rows in the caching database with new ones. The synchronization mechanism described herein may take care of synchronizing the slowly out-of-date knowledge with other NAP entities. Also, the centralized controller may choose to purge content database entries.

In an example, the database content in each NAP storage element may be a subset of the database in the centralized storage element. One of ordinary skill in the art will appreciate how the databases may relate. The following examples describe how the distributed databases in the NAP storage elements may be synchronized.

Let Tᵢ be the synchronization interval chosen for NAPᵢ. When the synchronization interval is triggered in NAPᵢ, the NAP storage controller may create a synchronization set that holds the CId and NAPId columns of its caching database. The NAP storage controller then may choose a NAPId in its neighborhood database and initiate the synchronization with the NAPId utilizing reconciliation methods. A NAP storage controller may use a local mechanism to decide which parameterization is used for defining the Bloom filters in the reconciliation. However, the parameterization may influence how many synchronization transfers are required until the synchronization is finalized and the databases are fully synchronized. Until the final exchange, the caching databases may be only probabilistically synchronized, i.e., there is a likelihood that entries are not properly synchronized, yielding pointers to wrong information, such as NAPIds. In such cases, the cache population mechanism may provide the appropriate fallback to the centralized controller in cases of erroneous NAP content retrieval requests.

Upon receiving a synchronization request from a NAP, the receiving NAP may reconcile its existing caching database entries with the received reconciliation set, forming a probabilistic synchronization between the two NAPs until the reconciliation is finished. NAPᵢ may choose to realize synchronizations with other NAPs per synchronization interval Tᵢ. In that case, the current synchronization may be finished once all NAPIds have been synchronized. In addition to one or more neighboring NAPs, NAPᵢ may initiate a set reconciliation with the centralized controller to update the appropriate columns in the centralized controller's content database.

In an example synchronization, the following choices may have a direct impact on key performance parameters. The number of NAPs being synchronized per interval Tᵢ may directly influence how many other NAP storage elements will be synchronized with the information in NAP. Therefore, the number of NAPs being synchronized per interval Tᵢ may directly influence how synchronized the overall system will be. The number of NAPs being synchronized per interval Tᵢ may also influence the used bandwidth for synchronization traffic.

The length of interval Tᵢ may also have a direct impact on key performance parameters. The more often the caching databases are synchronized, the knowledge regarding which content is located in which NAP may become more accurate. However, synchronizing more often may also increase the amount of synchronization traffic.

The dimensions of Bloom filters per synchronization set may also have a direct impact on key performance parameters. This may directly influence the probabilistic nature of the temporary reconciliation set within the receiving NAP and therefore the probability to issue false content retrieval requests to outdated NAPIds. The dimensions of Bloom filters per synchronization may also influence the burstiness of the synchronization traffic, i.e., if the choice is to have less bursty synchronization traffic, the duration of the probabilistic nature of the reconciled sets increases.

In an example, the central controller (and, therefore, the original content) may be hosted with a cloud provider, while the individual base station components may be hosted by individual operators. The collection of NAPs that is provided by the central controller with content may represent a geographical location (where different NAPs might belong to different operators covering this location) or a temporal event (such as a sporting event or a music festival). The cloud-based central controller may host the relevant content for these NAPs. Third party cloud providers may implement the location/event/organization-specific logic for the management of content. The content may be distributed as described above. The third party cloud providers could charge for management of the content on, for example, a service basis where the service could be a tourist experience.

In another example, the central controller may be hosted by a single operator and be an operator-based central controller, serving exclusively NAPs deployed by the operator. In this example, content may be provided towards the central controller by, for example, organizers of local events, through operator-specific channels (such as publication interfaces). The content may be distributed as described above and the content may be distributed to (operator-owned) NAPs. The operator may charge for optimal distribution of the content through using proprietary information, such as network utilization or mobility patterns, in the prediction for the content management.

In another example, the central controller may be hosted by a facility owner, such as a manufacturing company or a shopping mall, and be a facility-based central controller, in order to provide, for example, process-oriented content efficiently to the users of the facility. The NAPs of the content distribution system may be owned and deployed by the facility owner. The content may be distributed as described above. The facility owner may charge for an experience that is associated with the facility, like the immersive experience within a theme park or museum. The facility owner might add an additional charge for an improved immersive experience, compared to a standard operator-based solution, and may rely on proprietary facility information for improving the prediction used in the content management implementation within the central controller. Further, the facility owner may rely on the methods disclosed herein to distribute the content to the NAPs of the facility.

In an example, content retrieval may be based on metadata referral, i.e., the centralized manager provides a CId, which is used to retrieve the actual content. The content IDs may be constant length or human-readable variable length names. The final delivery may be a variable sized content object. In addition to content retrieval requests, there may be a frequent exchange of cache status reports. These reports may be larger than individual metadata requests and may not be prepared by CId retrieval requests.

In an example, the traffic exchanged between NAPs may be that of large bulk transfer with decreasing size. The decreasing size of the synchronization traffic may reflect the increasing convergence of the reconciliation sets.

In an example, content retrieval requests to particular NAPs may be likely to fail with some probability, resulting in secondary retrieval requests (either from other NAPs or from the central manager). A pattern of retrieval may indicate a statistical nature a cache report information and may indicate probabilistic synchronization between NAPs.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-35. (canceled)

36. A method for use in a caching system, in a small-cell network, the caching system having a centralized manager and a plurality of network attachment points (NAPs), the method comprising:
receiving, by each NAP of the plurality of NAPs, a list of unique NAP identifiers (NAPIds) of neighboring NAPs of the plurality of NAPs at regular intervals;
synchronizing, by a first NAP of the plurality of NAPs, a caching database of the first NAP with caching databases of the neighboring NAPs, wherein the caching databases of the first NAP and neighboring NAPs are probabilistically synchronized using Bloom filters until synchronization is complete;
receiving, by a first NAP, a first content request for a requested content;
determining, by the first NAP, the NAPId of a second NAP of the plurality of NAPs probabilistically holding the requested content on a condition that the requested content is not located in the caching database of the first NAP;
issuing, by the first NAP, a second content request for the requested content to the second NAP, based on the determination of the NAPId of the second NAP;
on a condition that the requested content is located in a caching database of the second NAP, delivering, by the second NAP, the requested content to the first NAP, and delivering, by the first NAP, the requested content to a wireless transmit/receive unit (WTRU) of an end user; and
on a condition that the requested content is not located in the caching database of the second NAP, delivering, by the second NAP, a first miss message to the first NAP;
wherein the plurality of NAPs are base stations in a small-cell network.

37. The method as in claim 36 further comprising:
receiving, by the first NAP, the first miss message.

38. The method as in claim 37 further comprising:
issuing, by the first NAP, a third content request for the requested content to the centralized manager on a condition of the receipt of the first miss message.

39. The method as in claim 37 further comprising:
determining, by the first NAP, the NAPId of a third NAP of the plurality of NAPs likely holding the requested content on a condition of the receipt of the first miss message;
issuing, by the first NAP, a third content request for the requested content to the third NAP, based on the determination of the NAPId of the third NAP;
delivering, by the third NAP, the requested content to the first NAP on a condition that the requested content is located in a caching database of the third NAP; and
delivering, by the third NAP, a second miss message to the first NAP on a condition that the requested content is not located in the caching database of the third NAP.

40. The method as in claim 39 wherein the determination of the NAPId of a third NAP likely holding the requested content is based on the third NAP probabilistically holding the requested content.

41. The method as in claim 36 further comprising:
creating, by the first NAP, a synchronization set containing one or more content identifiers and one or more NAPIds of the caching database of the first NAP at set intervals.

42. A method for use in a first network attachment point (NAP) of a plurality of NAPs, the method comprising:
receiving, by the first NAP, a list of unique NAP identifiers (NAPIds) of neighboring NAPs of the plurality of NAPs at regular intervals;
synchronizing, by the first NAP, a caching database of the first NAP with caching databases of neighboring NAPs, wherein the caching databases of the first NAP and neighboring NAPs are probabilistically synchronized using Bloom filters until synchronization is complete;
receiving, by the first NAP, a content request for a requested content;
determining, by the first NAP, the NAPId of a second NAP of the plurality of NAPs probabilistically holding the requested content on a condition that the requested content is not located in the caching database of the first NAP;
issuing, by the first NAP, a content request for the requested content to the second NAP, based on the determination of the NAPId of the second NAP; and
receiving, by the first NAP, the requested content; and delivering, by the first NAP, the requested content to a wireless transmit/receive unit (WTRU) of an end user;
wherein the plurality of NAPs are base stations in a small-cell network.

43. The method as in claim 42, further comprising:
creating, by the first NAP, a synchronization set containing one or more content identifiers and one or more NAPIds of the caching database of the first NAP at set intervals.

44. A caching system in a small cell network, the caching system comprising:
a centralized manager;
a plurality of network attachment points (NAPs);
each NAP of the plurality of NAPs configured to receive a list of unique NAP identifiers (NAPIds) of neighboring NAPs of the plurality of NAPs at regular intervals;
the first NAP configured to synchronize a caching database of the first NAP with caching databases of neighboring NAPs, wherein the caching databases of the first NAP and neighboring NAPs are probabilistically synchronized using Bloom filters until synchronization is complete
the first NAP further configured to receive a first content request for a requested content;
the first NAP further configured to determine the NAPId of a second NAP of the plurality of NAPs probabilistically holding the requested content on a condition that the requested content is not located in the caching database of the first NAP;
the first NAP further configured to issue a second content request for the requested content to the second NAP, based on the determination of the NAPId of the second NAP;
on a condition that the requested content is located in a caching database of the second NAP, the second NAP configured to deliver the requested content to the first NAP and the first NAP further configured to deliver the requested content to a wireless transmit/receive unit (WTRU) of an end user; and
on a condition that the requested content is not located in the caching database of the second NAP, the second NAP further configured to deliver a first miss message to the first NAP;
wherein the plurality of NAPs are base stations in a small-cell network.

45. The caching system of claim 44 further comprising:
a first NAP further configured to receive the first miss message.

46. The caching system of claim 45 further comprising:
the first NAP further configured to issue a third content request for the requested content to the centralized manager on a condition of the receipt of the first miss message.

47. The caching system of claim 46 further comprising:
the first NAP further configured to determine the NAPId of a third NAP of the plurality of NAPs likely holding the requested content on a condition of the receipt of the first miss message;
the first NAP further configured to issue a third content request for the requested content to the third NAP, based on the determination of the NAPId of the third NAP;
the third NAP configured to deliver the requested content to the first NAP on a condition that the requested content is located in a caching database of the third NAP; and
the third NAP further configured to deliver a second miss message to the first NAP on a condition that the requested content is not located in the caching database of the third NAP.

48. The caching system of claim 47 wherein the determination of the NAPId of a third NAP likely holding the requested content is based on the third NAP probabilistically holding the requested content.

49. The caching system of claim 44 further comprising:
the first NAP further configured to create a synchronization set containing one or more content identifiers and one or more NAPIds of the caching database of the first NAP at set intervals.
